(19) United States
(12) Patent Application Publication
(10) Pub. No.: US 2016/0328728 A1
(43) Pub. Date: Nov. 10, 2016

(54) METHOD AND SYSTEM FOR LINKING TRANSACTIONAL DATA TO BEHAVIORAL AND PURCHASE ACTIVITY BASED ON LOCATION

(71) Applicant: MasterCard International Incorporated, Purchase, NY (US)

(72) Inventors: Eugene KHVOSTOV, Cliffside Park, NJ (US); Kent Olof Niklas BERNTSSON, Rye, NY (US)

(73) Assignee: MASTERCARD INTERNATIONAL INCORPORATED, Purchase, NY (US)

(21) Appl. No.: 14/705,350

(22) Filed: May 6, 2015

(51) Int. Cl. G06Q 30/02

(52) U.S. Cl. CPC G06Q 30/0205

(57) ABSTRACT

A method for providing purchase behaviors based on geolocation and biometric data includes: storing transaction data entries, each entry including data related to a payment transaction including an account identifier, a geographic location, biometric data, and transaction data; receiving a data request, the request including a specific account identifier, a specific geographic location, and biometric data; identifying a subset of transaction data entries where each transaction data entry in the subset includes the specific account identifier and the specific geographic location; identifying purchase behaviors based on the transaction data included in each transaction data entry in the subset and a correspondence between the biometric data in the data request and the biometric data in each transaction data entry; and transmitting the identified purchase behaviors in response to the received data request.

### FIELD

The present disclosure relates to the linking of transaction data to behavioral and purchase activity based on a consumer's geographic location, specifically the linking of location and biometric data for a consumer to their purchase behavior.

### BACKGROUND

As the consumer market becomes more and more competitive, merchants, retailers, manufacturers, advertisers, content providers, and other entities often try and identify as much as information as they can about consumers. The more than an entity knows about a consumer, they more they can tailor content to fit that consumer, and the more they can pick and choose to which consumers they provide content. Such types of targeting techniques can often be successful in increasing the rate of effectiveness of advertising and other content distribution campaigns. However, while the rate of effectiveness is often higher using current techniques, entities are often still interested in raising the effectiveness of their distributed content even more.

One existing technique that is used for the targeting of consumers is a consumer's geographic location. By knowing where a consumer is, content can sometimes be tailored to influence a consumer based on their location, such as by advertising a nearby merchant. In other instances, a merchant hoping to drive traffic to their location may only advertise to consumers nearby, hoping to take advantage of their proximity. While such techniques may be useful, they are often driven by the association of the consumer's geographic location to the merchant. Therefore, not only is historical behavior of the consumer often not considered, but such techniques are also only beneficial for merchants with brick and mortar locations, and not Internet-based or other types of remote transactions.

Thus, there is a need for a technical solution to identify a consumer's geographic location and correlate it with historical transaction data for the consumer in order to identify a consumer's purchase behavior based on their current geographic location that may be used irrespective of the proximity to a merchant. Existing systems are often unable to obtain or store transaction data, due to restrictions on security, due to privacy protections, and due to specialized communication protocols and data standards used in the transmission and storage of transaction data. As a result, existing systems are unable to obtain transaction data for such uses, and therefore also unable to analyze the data for use in identifying linkages between transaction data and geographic location.

In addition, these systems are often also limited to obtaining the current geographic location of a consumer without any additional data. The use of additional data, which existing systems may be unable to receive or use depending on the sensitivity of the data involved, may provide further assistance in the linkage of a consumer's transaction data to their purchase behavior. For example, biometric data may be used to provide for even stronger analysis regarding a consumer's current purchase behaviors based on the same data found in prior transactions. However, like with transaction data, these systems are often unable to receive and store biometric data, due to the systems' inability to obtain, store, and protect such sensitive data. As a result, there is a need for an improved technical system that is specially configured to acquire and store transaction and biometric data for consumers for use in identifying consumer purchase behaviors, without compromising consumer privacy or security.

### SUMMARY

The present disclosure provides a description of systems and methods for providing purchase behaviors based on geolocation and biometric data.

A method for providing purchase behaviors based on geolocation and biometric data includes: storing, in a database, a plurality of transaction data entries, wherein each transaction data entry includes data related to a payment transaction including at least an account identifier of a plurality of account identifiers, a geographic location of a plurality of geographic locations, biometric data, and transaction data; receiving, by a receiving device, a data request, wherein the data request includes at least a specific account identifier, a specific geographic location, and biometric data; identifying, by a processing device, a subset of transaction data entries stored in the database where the account identifier and geographic location included in each transaction data entry in the subset corresponds to the specific account identifier and the specific geographic location, respectively; identifying, by the processing device, one or more purchase behaviors based on at least the transaction data included in each transaction data entry in the identified subset and a correspondence between the biometric data included in the received data request and the biometric data included in each transaction data entry in the identified subset; and transmitting, by a transmitting device, the identified one or more purchase behaviors in response to the received data request.

A system for providing purchase behaviors based on geolocation and biometric data includes a database, a receiving device, a processing device, and a transmitting device. The database is configured to store a plurality of transaction data entries, wherein each transaction data entry includes data related to a payment transaction including at least an account identifier of a plurality of account identifiers, a geographic location of a plurality of geographic locations, biometric data, and transaction data. The receiving device is configured to receive a data request, wherein the data request includes at least a specific account identifier, a specific geographic location, and biometric data. The processing device is configured to: identify a subset of transaction data entries stored in the database where the account identifier and geographic location included in each transaction data entry in the subset corresponds to the specific account identifier and the specific geographic location, respectively; and identify one or more purchase behaviors based on at least the transaction data included in each transaction data entry in the identified subset and a correspondence between the biometric data included in the received data request and the biometric data included in each transaction data entry in the identified subset. The transmitting device is configured to transmit the identified one or more purchase behaviors in response to the received data request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing purchase behaviors based on geolocation and biometric data in accordance with exemplary embodiments.

FIG. 2 is a block diagram illustrating the processing server of FIG. 1 for associating geolocation and biometric data with transaction data and use thereof for identifying purchase behaviors in accordance with exemplary embodiments.

FIG. 3 is a flow diagram illustrating a process for providing targeted content to consumers based on purchase behaviors identified using geolocation and biometric data using the system of FIG. 1 in accordance with exemplary embodiments.

FIG. 4 is a diagram illustrating the correlation of geolocation and biometric data to transaction data for use in providing purchase behaviors in accordance with exemplary embodiments.

FIG. 5 is a flow chart illustrating an exemplary method for providing purchase behaviors based on geolocation and biometric data in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal , etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Providing Geolocation- and Biometric-Based Purchase Behaviors

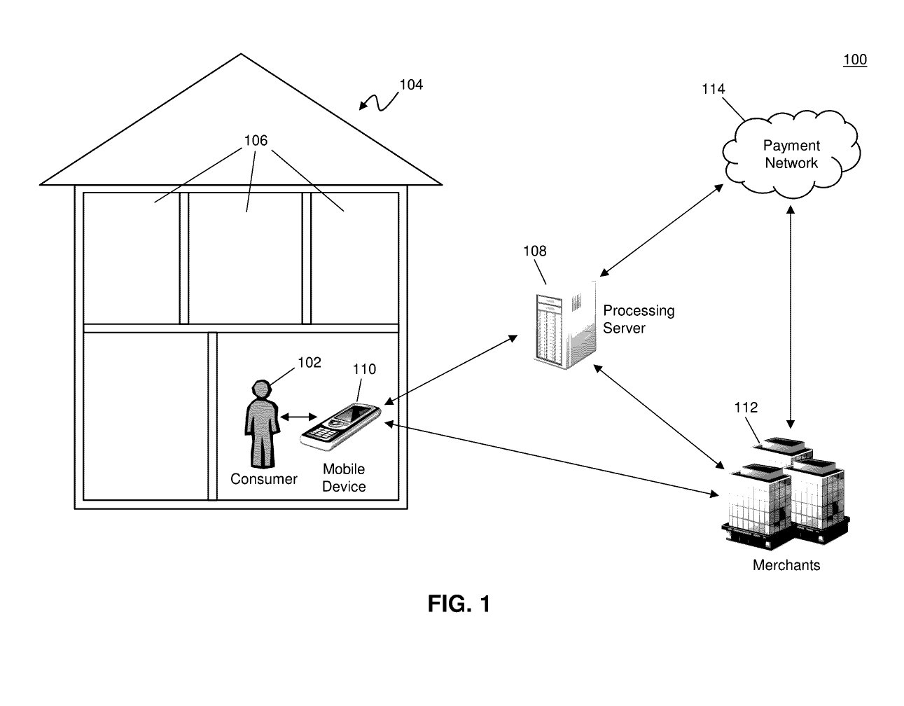

FIG. 1 illustrates a system 100 for linking transaction data to geolocation and biometric data for a consumer for use thereof in providing purchase behaviors.

In the system 100, a consumer 102 may be located in a geographic area 104, such as a home, office, or other area that may be associated with the consumer 102 where the consumer 102 may make purchases. The geographic area 104 may include a plurality of geographic locations 106. Each geographic location 106 may be represented by any suitable type of location representation, such as coordinates (e.g., latitude and longitude), an address, a room, etc. For example, in the illustration in FIG. 1, the geographic locations 106 may refer to rooms in the consumer's house where the consumer 102 may make purchase.

The system 100 may include a processing server 108. The processing server 108, discussed in more detail below, may be configured to link transaction data for the consumer 102 with geolocations of the consumer 102, such as using the geographic locations 106 in the geographic area 104 of the consumer 102 at the times of the linked transactions, as well as biometric data. The consumer 102 may conduct payment transactions with one or more merchants 112. The payment transactions may be processed by one or more payment networks 114 using methods and systems that will be apparent to persons having skill in the relevant art. The processing server 108 may be configured to receive transaction data associated with the consumer 102 from the merchants 112 and/or payment networks 114. In some embodiments, the transaction data may be formatted pursuant to one or more standards regarding the transmission of transaction data, such as the International Standard for Organization's ISO 8583 standard. In such embodiments, the processing server 108 may be specially configured with the appropriate communication protocols to receive data pursuant to such standards and for the analysis thereof.

The consumer 102 may have one or more mobile devices 110. The mobile device 110 may be any type of mobile computing and/or communication device suitable for performing the functions disclosed herein, such as a cellular phone, smart phone, tablet computer, laptop computer, notebook computer, wearable computing device, smart watch, implanted computing device, etc. When the consumer 102 conducts a payment transaction, the mobile device 110 may identify a geographic location of the consumer 102 as well as any suitable biometric data. Biometric data may include, for example, heart rate, respiration rate, hydration level, blood pressure, movement speed, body temperature, etc. The mobile device or devices 110 that capture the geolocation and biometric data may transmit the data to the processing server 108. The processing server 108 may match the geolocation and biometric data to transaction data associated with the consumer 102, such as based on the corresponding times.

In some embodiments, the consumer 102 may provide the processing server 108 with explicit consent in order to receive and store the geolocation, biometric, and transaction data. In some instances, the processing server 108 may receive and store data associated with a consumer 102 anonymously and without the use of any personally identifiable information, in order to provide additional privacy and security for the consumer 102. In such instances, data may be associated with the consumer 102 using a special identifier that is not personally identifiable with the consumer 102. Additional data, such as biometric data, may not be identifiable to the consumer 102, and any information that may be identifiable, such as a geolocation, may be encrypted, hashed, or otherwise rendered non-personally identifiable. As a result, the processing server 108 may obtain and store transaction data linked with geolocation and biometric data for a consumer 102, without obtaining and storing any personally identifiable information, and thereby preserve a high level of consumer privacy and security.

The processing server 108 may thus store transaction data for a consumer 102 that is associated with the consumer's geolocation and biometric data at the time of each respective transaction. The transaction data may include transaction amount, transaction time and/or date, product data, merchant data, offer data, loyalty data, reward data, etc. The processing server 108 may be configured to identify purchase behaviors for the consumer 102 based on the transaction data and the associated geolocation and biometric data. Purchase behaviors may include consumer propensities to conduct payment transactions as associated with a plurality of criteria, such as a propensity to purchase a specific product or type of product, purchase at a specific merchant or type of merchant, spend a specific amount or range of amounts, purchase at a given time or within a range of time, etc. For example, purchase behaviors may include the consumer's propensity to purchase electronics, propensity to purchase clothing, propensity to purchase women's clothing, propensity to purchase women's clothing from a specific designer or at a specific merchant, propensity to spend more than $50, propensity to conduct a payment transaction in the next six hours, propensity to conduct a payment transaction for a product upon viewing an advertisement, etc.

The processing server 108 may be configured to identify the consumer purchase behaviors as associated with the geolocation and/or biometric data of the consumer 102. For example, the processing server 108 may identify different propensities for the consumer 102 based on the consumer's geolocation, such as different purchase behaviors for each geographic location 106 in the geographic area 104, and/or associated with biometric data. For instance, the processing server 108 may identify the consumer's propensity to purchase sporting goods for each geographic location 106 and for a plurality of ranges of the consumer's heart rate.

The processing server 108 may be configured to provide the purchase behaviors for a consumer 102 to merchants 112, advertisers, content distributors, etc. The entities may then use the purchase behaviors in order to distribute content to the consumer 102. Due to the use linkages between biometric data, geolocation data, and transaction data, the purchase behaviors may be significantly more effective than the use of a consumer geolocation alone for the identification of targeted content and of consumers 102 for distribution of content.

In some instances, a merchant 112 or other entity may request purchase behaviors for a specific consumer 102 from the processing server 108. The request may include the biometric and geolocation of the consumer 102, such as obtained via one or more consumer mobile devices 110 by the merchant 112 or a third party. In instances where the request does not include the biometric and geolocation data of the consumer 102, the processing server 108 may obtain the biometric and geolocation data for the consumer 102, such as directly from the mobile devices 110, or from one or more third parties configured to obtain such information. The processing server 108 may then identify transaction data associated with the consumer 102 that is linked with the consumer's current geolocation and biometric data. The processing server 108 may identify purchase behaviors for the consumer's current geolocation and biometric data using the identified transaction data, and provide the purchase behaviors to the merchant 112. The merchant 112 can then identify content for distribution to the consumer 102 based on the purchase behaviors.

In embodiments where the processing server 108 may not possess any personally identifiable information on consumers 102, the request provided by the merchant 112 may use an identifier not personally identifiable with the consumer 102, such as an identifier that has been encrypted, hashed, etc., or is otherwise not identifiable to a specific consumer 102. The processing server 108 may identify the purchase behaviors using the identifier, and return the data to the merchant 112. The merchant 112, having consumer contact information, may then distribute content to the consumer 102, without the processing server 108 having ever received or used personally identifiable information.

In some embodiments, a merchant 112 or other entity may provide the processing server 108 with a desired purchase behavior. The processing server 108 may receive biometric and geolocation data associated with a plurality of consumers 102, identify the associated transaction data, and then identify each consumer's propensity for the desired purchase behavior using the associated transaction data. The processing server 108 may identify suitable consumers (e.g., having a propensity for the purchase behavior as requested by the merchant 112), and provide an identifier or other suitable information to the merchant 112. The merchant 112 may thereby receive an optimal list of consumers 102 for targeting that has a significantly higher rate of effectiveness than existing targeting techniques as a result of the use of linked transaction, geolocation, and biometric data.

### Processing Server

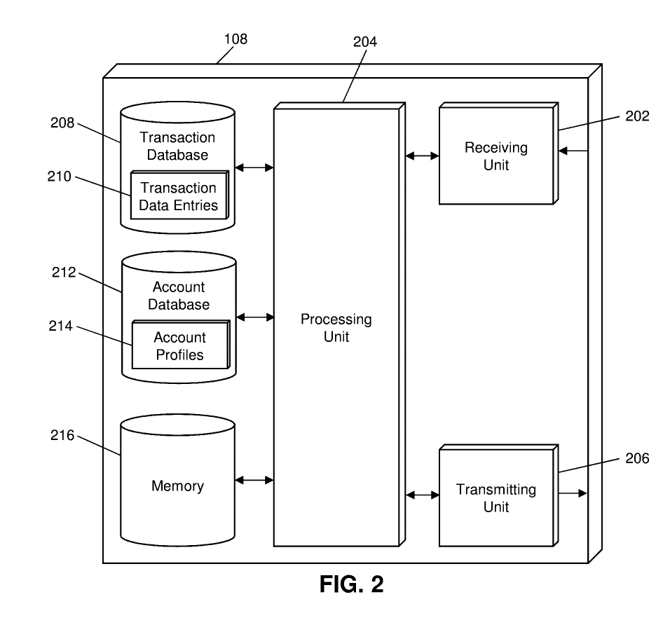

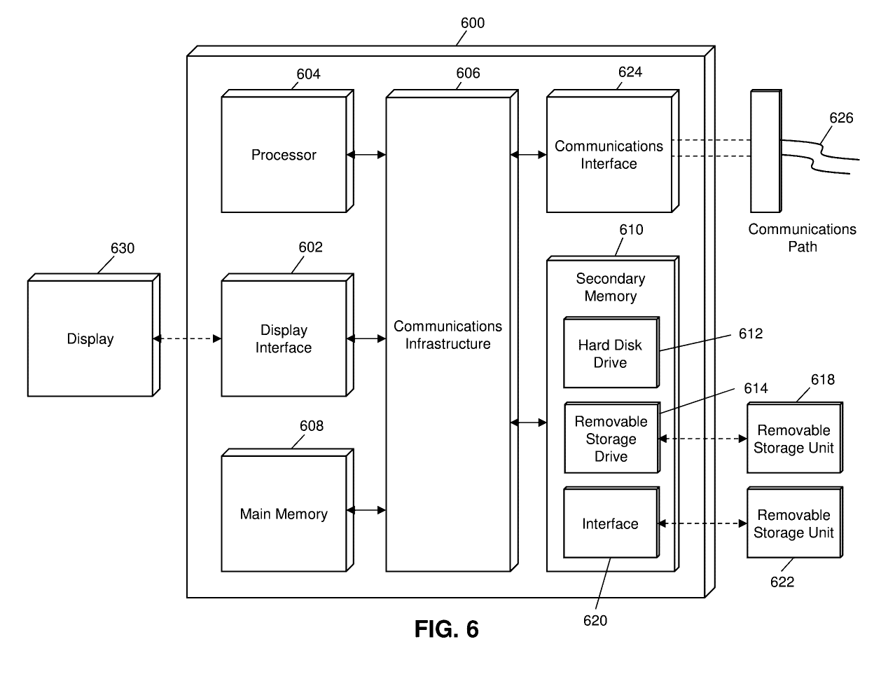

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 600 illustrated in FIG. 6 and discussed in more detail below may be a suitable configuration of the processing server 108.

The processing server 108 may include a receiving unit 202. The receiving unit 202 may be configured to receive data over one or more networks via one or more network protocols. For example, the receiving unit 202 may be configured to receive transaction data that may be included transaction messages formatted pursuant to one or more standards, such as the ISO 8583 standard for the interchange of transaction messages, which may be received using specialized protocols for the transmission of transaction data and/or specialized networks, such as networks operated by payment networks 114. The receiving unit 202 may also be configured to receive biometric data, geolocation data, and request data, such as from mobile devices 110, merchants 112, and third parties, such as mobile network operators, biometric data providers, etc.

The processing server 108 may also include a processing unit 204. The processing unit 204 may be configured to perform the functions of the processing server 108 as discussed herein as will be apparent to persons having skill in the relevant art. The processing unit 204 may be configured to store received transaction data in a transaction database 208 included in the processing server 108. The transaction database 208 may include a plurality of transaction data entries 210. Each transaction data entry 210 may include data related to a payment transaction including at least an account identifier, a geographic location, biometric data, and transaction data. The account identifier may be a unique value associated with a transaction account and/or consumer 102 involved in the payment transaction, such as an account number, username, e-mail address, phone number, etc. In some instances, the account identifier may be non-personally identifiable to the associated consumer 102.

In some embodiments, the processing unit 204 may be configured to match received biometric and geographic data to transactions. In such embodiments, the receiving unit 202 may receive transaction data and an associated account identifier for a transaction, and may separately receive biometric data and geolocation data and an associated account identifier. The processing unit 204 may be configured to associate the biometric data and geolocation data with transaction information, such as based on accompanying time information, such as the time of the reading of the biometric and geolocation data and a time of processing of the payment transaction.

In some embodiments, the processing server 108 may also include an account database 212. The account database 212 may be configured to store a plurality of account profiles 214. Each account profile 214 may be configured to store data related to a transaction account and/or a consumer 102. Data stored in account profiles 214 may include, for instance, an associated account identifier, identified purchase behaviors, a list of associated geographic locations 106, biometric data, demographic data, or any other data that may be used in conjunction with the methods and systems discussed herein that will be apparent to persons having skill in the relevant art. In some instances, transaction data entries 210 may be stored in an account profile 214 associated with the included account identifier. In such an instance, the processing server 108 may not include a separate transaction database 208.

The processing unit 204 may be further configured to identify purchase behaviors for a consumer 102 and/or transaction account. The processing unit 204 may identify transaction data entries 210 that include a specific account identifier, such as included in a request submitted by a merchant 112 or other entity and received by the receiving unit 202. The processing unit 204 may then identify purchase behaviors based on the transaction data included in the identified transaction data entries. In some instances, the purchase behaviors may be associated with geolocation and/or biometric data. In some cases, the transaction data entries 210 used to identify purchase behaviors may include specific geolocation and/or biometric data, such as included in a request received by the receiving unit 202 or received from a third party in association with a request received by the receiving unit 202. The processing unit 204 may also be configured to identify account profiles 214 based on identified purchase behaviors, such as account profiles with a purchase behavior having a specific propensity as indicated in a request received by the receiving unit 202.

The processing server 108 may also include a transmitting unit 206. The transmitting unit 206 may be configured to transmit data over one or more networks via one or more network protocols. The transmitting unit 206 may transmit purchase behaviors and/or account identifiers to a third party, such as in response to a request for purchase behaviors or accounts. The transmitting unit 206 may also be configured to transmit data requests, such as to a payment network 114 for transaction data, to mobile devices 110 for biometric and/or geolocation data, to third parties for biometric and/or geolocation data, etc.

The processing server 108 may also include a memory 216. The memory 216 may be configured to store data suitable for use by the processing server 108 in performing the functions disclosed herein. For example, the memory 216 may be configured to store rules or algorithms for the identification of purchase behaviors, data used in the analysis of transaction data, biometric data, and geolocation data, encryption keys and/or algorithms, etc. Additional data that may be included in the memory 216 will be apparent to persons having skill in the relevant art.

It will also be apparent to persons having skill in the relevant art that, in some instances, the processing server 108 may include additional components, and/or that the components included in the processing server 108 as illustrated in FIG. 2 and discussed herein may be configured to perform additional and/or alternative functions. For example, in some embodiments, the processing server 108 may be a part of the payment network 114. In such an embodiment, the processing server 108 may include additional components and/or the components in the processing server 108 as illustrated in FIG. 2 may be configured to perform the traditional functions of a payment network 114, such as for the processing of payment transactions.

### Process for Providing Content Based on Geolocation- and Biometric-Based Purchase Behaviors

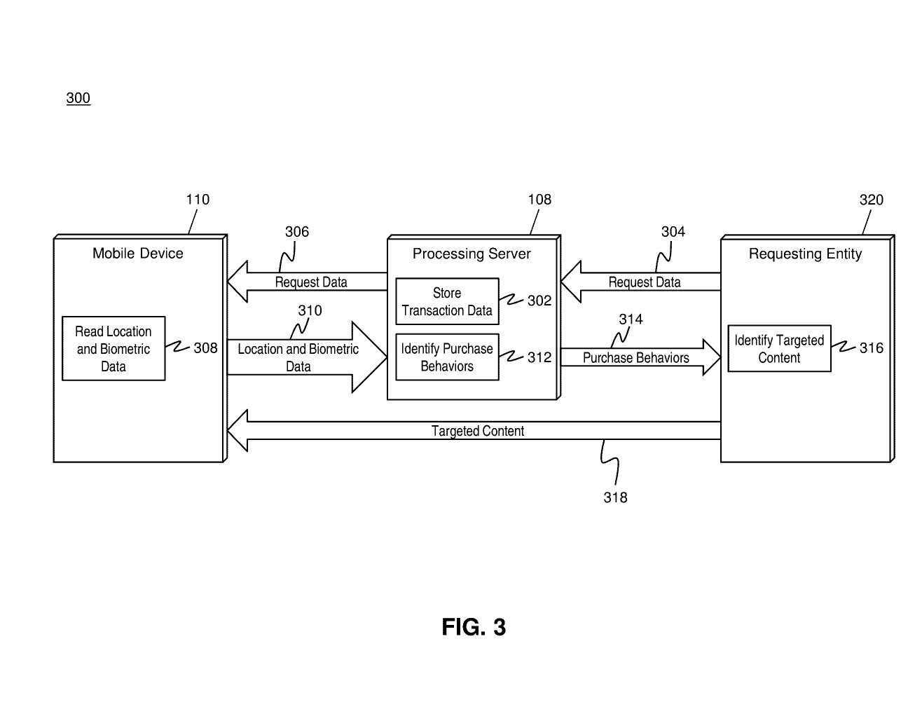

FIG. 3 illustrates a process 300 for the providing of targeted content to a consumer 102 identified based on the consumer's geolocation and biometric data and associated purchase behaviors using the system 100.

In step 302, the processing server 108 may store transaction data, such as in the transaction database 208 and/or account database 212. The transaction data may be associated with biometric and geolocation data for a consumer 102 and/or transaction account involved in the related payment transaction. In step 304, a requesting entity 320, such as a merchant 112, advertiser, content provider, etc., may transmit a request for data to the processing server 108. The receiving unit 202 of the processing server 108 may receive the request, which may include an account identifier associated with a specific consumer 102, such as for the use in identifying current purchase behaviors, or may include a purchase behavior for which a plurality of account identifiers are requested.

In step 306, the transmitting unit 206 of the processing server 108 may transmit a request for data to one or more mobile devices 110. The mobile devices 110 may be devices configured to identify geolocations and biometric data of an associated consumer 102. The request may be transmitted to the mobile devices 110 for an individual consumer 102, such as when individual purchase behaviors are requested by the requesting entity 320, or may be transmitted to mobile devices 110 for a plurality of consumers 102, such as if multiple consumers 102 are requested by the requesting entity 320. In step 308, the mobile devices 110 may read the current geolocation and biometric data for the associated consumer 102. In step 310, the location and biometric data may be transmitted to the processing server 108, to be received by the receiving unit 202. It will be apparent to persons having skill in the relevant art that, in some instances, steps 306, 308, and 310 may be conducted via a third party. For instance, the processing server 108 may request the biometric and geolocation data from a mobile network operator associated with a mobile device 110, which may obtain the data from the mobile device 110 and provide it to the processing server 108.

In step 312, the processing unit 204 of the processing server 108 may identify purchase behaviors for the consumer 102 associated with the mobile devices 110. Identification of the purchase behaviors may include identifying transaction data entries 210 associated with the consumer 102 that include a geolocation and biometric data that correspond to those received from the mobile devices 110, and then identifying one or more purchase behaviors based on the transaction data included in each of the identified transaction data entries 210. In some embodiments, purchase behaviors that are identified may be indicated in the request received by the receiving unit 202 in step 304. For example, the request may name specific purchase behaviors, or may request only purchase behaviors where the associated propensity is above a specific threshold, such as where the consumer 102 has a high propensity to conduct a payment transaction.

In step 314, the transmitting unit 206 of the processing server 108 may transmit the identified purchase behaviors to the requesting entity 320. In instances where the requesting entity 320 requests account identifiers associated with a specific purchase behavior, step 314 may include transmitting the account identifiers for account profiles 214 whose identified purchase behavior satisfies the request. In step 316, the requesting entity 320 may identify targeted content for distribution to consumers 102 based on their purchase behaviors. In step 318, the content may be distributed to the consumers 102, such as via their mobile devices 110. The content may thus be more effective than content identified using traditional systems, because it is based on a purchase behavior identified for the consumer 102 based on their past transaction history for their current geolocation and biometric characteristics.

### Linkage of Transaction Data to Geolocation and Biometric Data

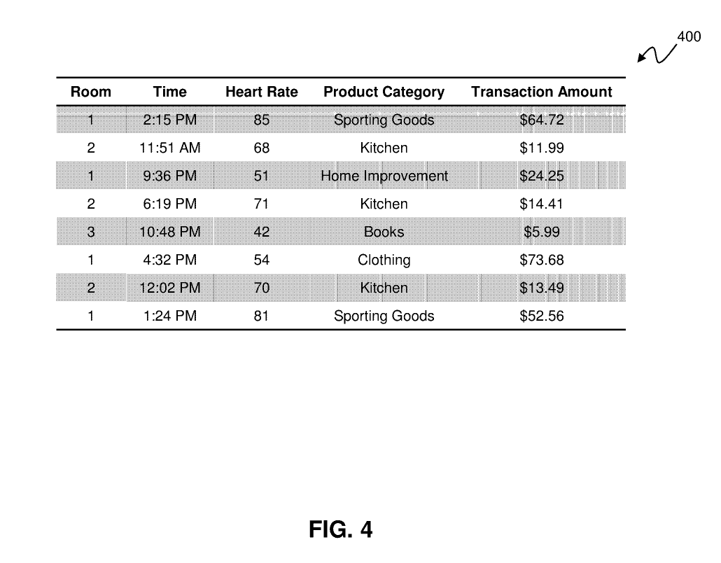

FIG. 4 illustrates the linkage of transaction data to geolocation and biometric data for a consumer 102 for use in identifying geolocation- and biometric-based purchase behaviors.

FIG. 4 includes a table 400. The table 400 includes data representative of a plurality of transaction data entries 210 associated with a specific consumer 102. Each transaction data entry 210 in the illustrated example includes transaction data, specifically a transaction time and/or date, product category, and transaction amount, as well as geolocation data, specifically a room location, and biometric data, specifically the consumer's heart rate, at the time the transaction was conducted.

The processing server 108 may be configured to analyze the information included in the transaction data entries 210 to identify one or more purchase behaviors for the consumer 102, assuming the consumer 102 has consented to such analysis. For example, using the data included in the example illustrated in FIG. 4, the processing server 108 may identify that the consumer 102 has a high propensity to buy sporting goods if the consumer 102 is in Room 1 with a heart rate over 80 beats per minute. In some instances, the processing server 108 may be configured to identify every such possible purchase behavior that may be associated with a combination of geolocation and biometric data for a consumer 102. In other instances, the processing server 108 may only do so upon request.

For example, the receiving unit 202 of the processing server 108 may receive a request from a merchant 112 for consumers 102 with a high propensity to purchase kitchen goods. If the processing server 108 identifies that the consumer 102 is in Room 1, the consumer 102 may not be identified as the consumer 102 may have a very low propensity to purchase kitchen goods when in Room 1. In another example, a requesting entity 320 may request to know what conditions may be suitable for distributing content related to kitchen goods to the consumer 102 may be, due to a high propensity for purchase of kitchen goods based on those conditions. The processing server 108 may identify instances when the consumer 102 is in Room 2,with a heart rate between 65 and 75 beats per minute as ideal, and provide the information to the requesting entity 320. In some instances, the processing server 102 may also specify a time with a higher propensity, such as around noon in the illustrated example.

### Exemplary Method for Providing Purchase Behaviors Based on Geolocation and Biometric Data

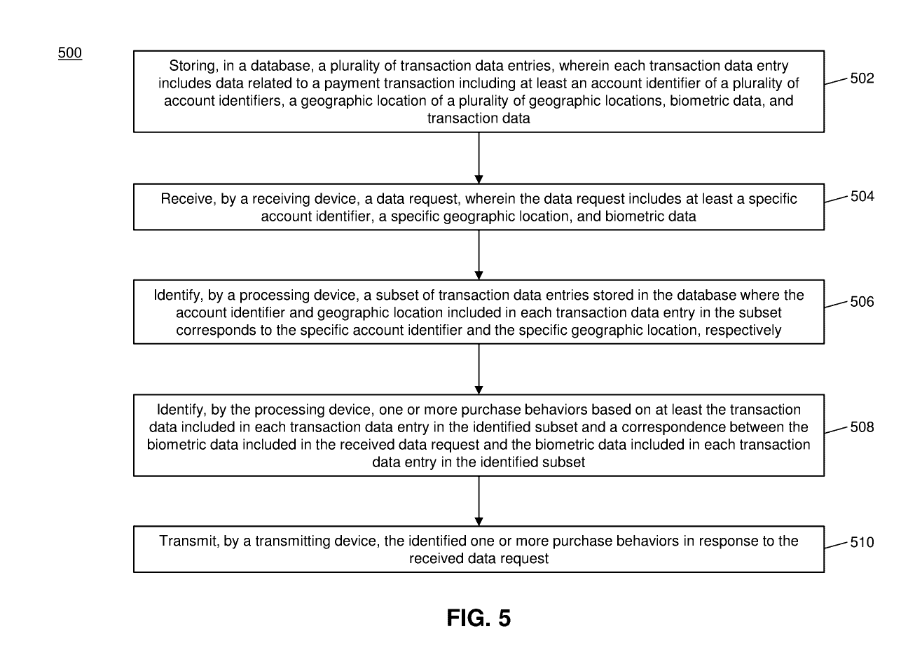

FIG. 5 illustrates a method 500 for providing purchase behaviors that are based on geolocation and biometric data and a linkage thereof with transaction data.

In step 502, a plurality of transaction data entries (e.g., transaction data entries 210) may be stored in a database (e.g., the transaction database 208 or account database 212), wherein each transaction data entry 210 includes data related to a payment transaction including at least an account identifier of a plurality of account identifiers, a geographic location of a plurality of geographic locations, biometric data, and transaction data. In one embodiment, the plurality of geographic locations may be associated with rooms or areas inside of a residential area associated with a consumer (e.g., the consumer 102) involved in the related payment transaction. In some embodiments, the biometric data may include at least one of: heart rate, respiration rate, blood pressure, movement speed, hydration, and body temperature.

In step 504, a data request may be received by a receiving device (e.g., the receiving unit 202), wherein the data request includes at least a specific account identifier, a specific geographic location, and biometric data. In one embodiment, the specific account identifier and the specific geographic location and biometric data are received in separate data requests, and the data request including the specific geographic location and the biometric data re received in response to a transmission, by a transmitting device, requesting the specific geographic location and biometric data. In step 506, a subset of transaction data entries stored in the database may be identified by a processing device (e.g., the processing unit 204) where the account identifier and geographic location included in each transaction data entry in the subset corresponds to the specific account identifier and the specific geographic location, respectively.

In step 508, one or more purchase behaviors may be identified by the processing device 204 based on at least the transaction data included in each transaction data entry 210 in the identified subset and a correspondence between the biometric data included in the received data request and the biometric data included in each transaction data entry 210 in the identified subset. In one embodiment, the one or more purchase behaviors may include one or more propensities to purchase a specific product, a specific type of product, a product associated with a specific manufacturer, a product at a specific merchant, a product at a specific type of merchant, a product during a specific period of time, a product in a specific geographic area, and one or more products having a specific range of transaction amounts.

In step 510, the identified one or more purchase behaviors may be transmitted by a transmitting device (e.g., the transmitting unit 206) in response to the received data request. In some embodiments, the method 500 may further include: receiving, by the receiving device 202, a plurality of data requests, wherein each data request includes a different account identifier; and repeating the identifying and transmitting steps for the different account identifier included in each data request of the plurality of data requests.

In one embodiment, the plurality of transaction data entries may be stored in a plurality of account profiles (e.g., account profiles 214), and each account profile 214 may include data related to a transaction account and includes transaction data entries 210 including a common account identifier associated with the related transaction account. In a further embodiment, each account profile 214 may further include a plurality of geographic locations, each transaction data entry 210 included in each account profile 214 includes a geographic location of the plurality of geographic locations included in the respective account profile 214, and each geographic location may be associated with a room or area inside of a residence associated with the related transaction account.

In some embodiments, the method 500 may also include: receiving, by the receiving device 202, an account request, wherein the account request includes a specific purchase behavior; determining, by the processing device 204, if at least one of the identified one or more purchase behaviors corresponds to the specific purchase behavior; and transmitting, by the transmitting device 206, the specific account identifier in response to the received account request if the processing device 204 produces a positive determination. In a further embodiment, the method 500 may even further include: receiving, by the receiving device, a plurality of data requests, wherein each data request includes a different account identifier; and repeating the identifying, transmitting, and determining steps for the different account identifier included in each data request of the plurality of data requests.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for providing purchase behaviors based on geolocation and biometric data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing purchase behaviors based on geolocation and biometric data, comprising:
storing, in a database, a plurality of transaction data entries, wherein each transaction data entry includes data related to a payment transaction including at least an account identifier of a plurality of account identifiers, a geographic location of a plurality of geographic locations, biometric data, and transaction data;
receiving, by a receiving device, a data request, wherein the data request includes at least a specific account identifier, a specific geographic location, and biometric data;
identifying, by a processing device, a subset of transaction data entries stored in the database where the account identifier and geographic location included in each transaction data entry in the subset corresponds to the specific account identifier and the specific geographic location, respectively;
identifying, by the processing device, one or more purchase behaviors based on at least the transaction data included in each transaction data entry in the identified subset and a correspondence between the biometric data included in the received data request and the biometric data included in each transaction data entry in the identified subset; and
transmitting, by a transmitting device, the identified one or more purchase behaviors in response to the received data request.

2. The method of claim 1, wherein the plurality of geographic locations are associated with rooms or areas inside of a residential area associated with a consumer involved in the related payment transaction.

3. The method of claim 1, wherein the plurality of transaction data entries are stored in a plurality of account profiles, and each account profile includes data related to a transaction account and includes transaction data entries including a common account identifier associated with the related transaction account.

4. The method of claim 3, wherein
each account profile further includes a plurality of geographic locations,
each transaction data entry included in each account profile includes a geographic location of the plurality of geographic locations included in the respective account profile, and
each geographic location is associated with a room or area inside of a residence associated with the related transaction account.

5. The method of claim 1, wherein the biometric data includes at least one of: heart rate, respiration rate, blood pressure, movement speed, hydration, and body temperature.

6. The method of claim 1, wherein the one or more purchase behaviors includes one or more propensities to purchase a specific product, a specific type of product, a product associated with a specific manufacturer, a product at a specific merchant, a product at a specific type of merchant, a product during a specific period of time, a product in a specific geographic area, and one or more products having a specific range of transaction amounts.

7. The method of claim 1, further comprising:
receiving, by the receiving device, a plurality of data requests, wherein each data request includes a different account identifier; and
repeating the identifying and transmitting steps for the different account identifier included in each data request of the plurality of data requests.

8. The method of claim 1, further comprising:
receiving, by the receiving device, an account request, wherein the account request includes a specific purchase behavior;
determining, by the processing device, if at least one of the identified one or more purchase behaviors corresponds to the specific purchase behavior; and
transmitting, by the transmitting device, the specific account identifier in response to the received account request if the processing device produces a positive determination.

9. The method of claim 8, further comprising:
receiving, by the receiving device, a plurality of data requests, wherein each data request includes a different account identifier; and
repeating the identifying, transmitting, and determining steps for the different account identifier included in each data request of the plurality of data requests.

10. The method of claim 1, wherein
the specific account identifier and the specific geographic location and biometric data are received in separate data requests, and
the data request including the specific geographic location and the biometric data are received in response to a transmission, by the transmitting device, requesting the specific geographic location and biometric data.

11. A system for providing purchase behaviors based on geolocation and biometric data, comprising:
a database configured to store a plurality of transaction data entries, wherein each transaction data entry includes data related to a payment transaction including at least an account identifier of a plurality of account identifiers, a geographic location of a plurality of geographic locations, biometric data, and transaction data;
a receiving device configured to receive a data request, wherein the data request includes at least a specific account identifier, a specific geographic location, and biometric data;
a processing device configured to
identify a subset of transaction data entries stored in the database where the account identifier and geographic location included in each transaction data entry in the subset corresponds to the specific account identifier and the specific geographic location, respectively, and
identify one or more purchase behaviors based on at least the transaction data included in each transaction data entry in the identified subset and a correspondence between the biometric data included in the received data request and the biometric data included in each transaction data entry in the identified subset; and
a transmitting device configured to transmit the identified one or more purchase behaviors in response to the received data request.

12. The system of claim 11, wherein the plurality of geographic locations are associated with rooms or areas inside of a residential area associated with a consumer involved in the related payment transaction.

13. The system of claim 11, wherein the plurality of transaction data entries are stored in a plurality of account profiles, and each account profile includes data related to a transaction account and includes transaction data entries including a common account identifier associated with the related transaction account.

14. The system of claim 13, wherein
each account profile further includes a plurality of geographic locations,
each transaction data entry included in each account profile includes a geographic location of the plurality of geographic locations included in the respective account profile, and
each geographic location is associated with a room or area inside of a residence associated with the related transaction account.

15. The system of claim 11, wherein the biometric data includes at least one of: heart rate, respiration rate, blood pressure, movement speed, hydration, and body temperature.

16. The system of claim 11, wherein the one or more purchase behaviors includes one or more propensities to purchase a specific product, a specific type of product, a product associated with a specific manufacturer, a product at a specific merchant, a product at a specific type of merchant, a product during a specific period of time, a product in a specific geographic area, and one or more products having a specific range of transaction amounts.

17. The system of claim 11, wherein
the receiving device is further configured to receive a plurality of data requests, wherein each data request includes a different account identifier, and
the processing device and transmitting device are further configured to repeat the identifying and transmitting steps, respectively, for the different account identifier included in each data request of the plurality of data requests.

18. The system of claim 11, wherein
the receiving device is further configured to receive an account request, wherein the account request includes a specific purchase behavior,
the processing device is further configured to determine if at least one of the identified one or more purchase behaviors corresponds to the specific purchase behavior, and
the transmitting device is further configured to transmit the specific account identifier in response to the received account request if the processing device produces a positive determination.

19. The system of claim 18, wherein
the receiving device is further configured to receive a plurality of data requests, wherein each data request includes a different account identifier, and
the processing device is further configured to repeat the identifying and determining steps, and the transmitting device is further configured to repeat the transmitting steps, for the different account identifier included in each data request of the plurality of data requests.

20. The system of claim 11, wherein the specific account identifier and the specific geographic location and biometric data are received in separate data requests, and
the data request including the specific geographic location and the biometric data are received in response to a transmission, by the transmitting device, requesting the specific geographic location and biometric data.
